(19) United States
(12) Patent Application Publication
(10) Pub. No.: US 2024/0181685 A1
(43) Pub. Date: Jun. 6, 2024

(54) PROCESS FOR CONTINUOUS PRODUCTION OF FOAMS USING AN AUXILIARY INLINE MIXER

(71) Applicant: Evonik Operations GmbH, Essen (DE)

(72) Inventors: YeChen Le, Shanghai (CN); Zheng Zhu, Shanghai (CN); Leihong Hu, Shanghai (CN); Liang Bao, Shanghai (CN)

(73) Assignee: Evonik Operations GmbH, Essen (DE)

(21) Appl. No.: 18/552,394

(22) PCT Filed: Mar. 26, 2021
(86) PCT No.: PCT/CN2021/083302

§ 371 Date: Sep. 25, 2023

(51) Int. Cl. B29C 44/34; B29K 33/00; B29K 75/00

(52) U.S. Cl. CPC B29C 44/3442; B29K 2033/08; B29K 2075/00

(57) ABSTRACT

A method can be used to improve the quality of a foam, produced in a process for continuous production of foams using a surfactant with higher molecular weight as an additive in an aqueous polymer dispersion. The process involves foaming a mixture of the aqueous polymer dispersion and the surfactant, and the mixture is mixed in a foaming machine with a mixing head line speed of less than 4 m/s. The process additionally involves mixing the foam obtained from the foaming machine in an auxiliary inline mixer connected to the foaming machine, at a mixing head line speed of 5˜50 m/s. A process for continuous production of foams and a continuous production line are also provided.

### TECHNICAL FIELD

The invention relates to a process to produce foams from water borne resins.

BACKGROUND ART Foamed water borne resin coated textile can be used in products like artificial leather, carpet backing, yoga pad and window shade, in which homogeneous cell usually will offer better haptic feeling and improved light blocking performance.

Water borne resin is usually recognized as synthetic or natural high molecular resin that uses water as the carrying medium. It is dispersible in water and can be either crosslinkable or non-crosslinkable. Common aqueous dispersions include polyurethane dispersion, polyarcylic dispersion and VAE dispersion, etc.

To offer stable and homogeneous cells in water borne resin foaming, it usually needs certain additives to stabilize the foam. For example, US 2015/0284902 A1 and US 2006/0079635 A1 disclosed some anionic surfactant used for the foaming. WO 2018/015260 A1 and WO 2019/042696 A1 disclosed non-ionic surfactants with higher molecular weight (Mw) than that of ammonium stearate for use in such application.

WO 2018/015260 A1 (CN 109476949 A) discloses polyol ester surfactants, especially the ionic derivatives thereof, furthermore the phosphorylated, sulphated derivatives and phosphorylated polyol ester surfactants. Polyol ester surfactants enable foaming of PUD (aqueous polyurethane dispersion) systems without having to accept the disadvantages commonly known with the use of ammonium stearate. A reason of using polyol esters is that they lead to a stabilization of foams based on aqueous polymer dispersions even without the use of further surfactants. On the other hand, polyol esters are also used in a blend with one or more co-surfactants as additives in aqueous polymer dispersions. Such co-surfactants may be fatty acid amides, alcohol alkoxylates, nonylphenol ethoxylates, ethylene oxide-propylene oxide block copolymers, betaines, for example amidopropyl betaines, amine oxides, quaternary ammonium surfactants or amphoacetates. In addition, the co-surfactant may be silicone-based one, for example trisiloxane surfactant or polyether siloxanes.

WO 2019/042696A1 (CN 111050897 A) discloses polyol ether surfactants for the use in the production of porous polymer coatings that enable the production of stable, processible foams. Polyol ethers encompass the alkoxylated adducts thereof, which are obtained by reaction of a polyol ether with alkylene oxides, for example ethylene oxide, propylene oxide and/or butylene oxide. Furthermore, polyol ethers also encompass polyol ester-polyol ether hybrid structures which are prepared by O-alkylation of polyol esters or by esterification of polyol ethers. The polyol ethers also encompass their ionic derivatives, e.g., the phosphorylated and sulphated derivatives, especially phosphorylated polyol ethers. Furthermore, polyol ether surfactants are used as additives in aqueous polymer dispersions for the production of of porous polyurethane coatings. Especially, polyol ethers can be used in a blend with at least one co-surfactant as additives in aqueous polymer dispersions. Such co-surfactants may be fatty acid amides, alcohol alkoxylates, nonylphenol ethoxylates, ethylene oxide-propylene oxide block copolymers, betaines, amine oxides, quaternary ammonium surfactants or amphoacetates, and silicone-based surfactants. Polyol ether surfactants are also well-known as stabilizers of foams based on aqueous polymer dispersions, even without the use of further surfactants.

However, in industrial and continuous production of foams from water borne resin which uses mixing device or foaming machine that has a mixing head line speed of less than 4 m/s, when using surfactants with molecular weight higher than that of ammonium stearate such as the polyol ester surfactants and polyol ether surfactants above, the obtained foamed layer often has cracks after drying, and the cells are very coarse. To solve this problem in continuous industrial application, there may be two possible options:
a) change the mixing device to increase the line speed of the mixer. However, the upgrade cost can be very high and is often not possible as new mixing device may have compatibility issue with the existing production line. Therefore, this option is not feasible both economically and from engineering perspective.
b) change the resin formulation, such as optimizing the choice of surfactants. However, it is technically very difficult and often not possible as the resin very much determines the performance of the finished coated products and a resin change will require a complete reformulation.

### SUMMARY OF THE INVENTION

To solve the technical problems of prior art, the inventors collected foam generated in a conventional foaming process and tried to mix it again in an industrial standard foaming machine. However, such additional process step cannot solve the technical problems of cracking and coarse cells.

Surprisingly, it has been found that using an auxiliary in-line mixer with a suitable range of mixing head line speed can conveniently and efficiently provide a much finer, more homogenous and stable foam using surfactants with molecular weight higher than the Mw of ammonium stearate as foam stabilizer in industrial and continuous production processes.

The invention provides a method to improve the quality of a foam such as the stability of the foam and the cell fineness of the foam, produced in a process for continuous production of foams using a surfactant with higher molecular weight as an additive in an aqueous polymer dispersion, the process comprises a step of foaming a mixture of an aqueous polymer dispersion and surfactant with higher molecular weight, and the mixture is mixed in a foaming machine with a mixing head line speed of less than 4 m/s;

wherein the process additionally comprises a step of mixing the foam obtained from the foaming machine in an auxiliary inline mixer connected to the foaming machine, at a mixing head line speed of 5˜50 m/s, for example, 5˜40 m/s, such as 5˜30 m/s, preferably 6˜20 m/s.

The invention further provides a process for continuous production of foams using a surfactant with higher molecular weight as an additive in an aqueous polymer dispersion, comprising a step of foaming a mixture comprising an aqueous polymer dispersion and the surfactant with higher molecular weight, and the mixture is mixed in a foaming machine with a mixing head line speed of less than 4 m/s; wherein the process additionally comprises a step of mixing the foam obtained from the foaming machine in an auxiliary inline mixer connected to the foaming machine, at a mixing head line speed of 5˜30 m/s, preferably 6˜20 m/s.

Thus, the present invention provides an auxiliary inline mixer with a mixing head line speed of from 5 to 30 m/s, preferably 6˜20 m/s for the industrial and continuous production of foamed water borne resin using a surfactant with higher molecular weight as a foaming additive. Use of such inline mixer can greatly reduce cell size and improve stability of the foamed water borne resin.

In the invention, the outlet flow rate of the foaming machine should match the inlet flow rate of the auxiliary in-line mixer.

As used herein, the term “auxiliary inline mixer” in the invention refers to an inline mixer additionally connected to the original foaming machine which has a mixing head line speed of less than 4 m/s.

As used herein, the term “mixing head line speed” in the invention refers to the line speed of the outermost of the mixing head, which is the maximum line speed in the whole mixing head.

As used herein, the term “surfactant with higher molecular weight” in the invention refers to surfactants that have higher molecular weight (Mw) than the Mw of ammonium stearate (301.5 g/mol), and such surfactants can be used as a foaming agent in conventional water borne resin foaming process in a foaming machine with a mixing head line speed of less than 4 m/s.

The invention further provides use of an auxiliary inline mixer in a process for continuous production of foams using a surfactant with higher molecular weight as an additive in an aqueous polymer dispersion to improve the quality of the foams such as the stability of foam and the fineness of foam, wherein the process comprises a step of foaming a mixture of an aqueous polymer dispersion and surfactant with higher molecular weight, and the mixture is mixed in a foaming machine with a mixing head line speed of less than 4 m/s;

wherein the process comprises a step of mixing the foam obtained from the foaming machine in an auxiliary inline mixer connected to the foaming machine, at a mixing head line speed of 5˜30 m/s, preferably 6˜20 m/s.

The invention further provides a continuous production line for production of foams using a surfactant with higher molecular weight as an additive in an aqueous polymer dispersion, comprising a foaming machine with a mixing head line speed of less than 4 m/s, a coating device and a drying device; wherein the production line additionally comprises an auxiliary inline mixer capable of achieving a mixing head line speed of 5˜30 m/s, preferably 6˜20 m/s; and

the inlet of the inline mixer is connected to the outlet of the foaming machine, and the outlet of the inline mixer is connected to the inlet of the coating device.

The invention further provides a process for continuous production of a porous water borne foamable resin (such as polyurethane) coating, using a surfactant with higher molecular weight as an additive in an aqueous polymer dispersion, which comprises the steps of:
a) providing a mixture comprising of an aqueous polymer dispersion, a surfactant with higher molecular weight, and other necessary additives such as thickener, filler and dispersant;
b) foaming the mixture to give foams, wherein the mixture is mixed in a foaming machine at a mixing head line speed of less than 4 m/s;
c) mixing the foam obtained from step b) in an auxiliary inline mixer connected to the foaming machine of step b), at a line speed of a mixing head from 5˜30 m/s, preferably 6˜20 m/s, to obtain foams with homogeneous and fine cell structure;
d) applying a coating of the foamed polymer dispersion to a suitable carrier, and
e) drying the coating.

The process of the invention can reduce the cell size and improve the stability of foamed water borne resin.

It is not obvious for a person skilled in the art to use an auxiliary in-line mixer with suitable range of line speed to solve the problem existed in industrial and continuous production of a foam from water borne resin with surfactants with higher molecular weight. The reasons include:
a) it is not obvious to use such an in-line mixer with desired mixing speed in this field. Such auxiliary in-line mixer has never been used in industrial scale continuous production in the technical field. Furthermore, it is never used in foaming industry even in lab scale continuous production.
b) the in-line mixer should be specially adapted or chosen to integrate into the production line, e.g., the in-line mixer should be mounted with pipelines that can be directly connected to the upstream foaming machine and downstream coating devices, and the outlet flow rate of the foaming machine should match the inlet flow rate of the auxiliary in-line mixer. It is not possible to directly use a commercial mixer without proper adaption to the production line.
c) the in-line mixer should provide a particular range of mixing head line speed of 5˜30 m/s to obtain good foaming performance. Simply adding the in-line mixer without controlling the mixing speed will not work. If the mixing speed is not high enough or too high, the desired foaming performance will not be achieved.
d) it is surprising that instead of replacing the whole foaming machine, simple use of an in-line mixer with proper mixing speed as an additional device added to a conventional industrial continuous production line and in combination to a conventional foaming machine may successfully solve the technical problems including cracks on foamed layer after drying, and very coarse cells when using surfactant with higher molecular weight as foam stabilizer, in a very efficient and economical way.

Thus, the invention successfully solves the technical problems existing in industrial and continuous production of foams with water borne resin with surfactants with higher molecular weight, in a surprisingly economical and efficient way.

A person skilled in the art knows that the aqueous polymer dispersion is foamable by mechanical mixing. In some embodiments, the aqueous polymer dispersions are selected from the group of aqueous polystyrene dispersions, polybutadiene dispersions, poly(meth)acrylate dispersions, polyvinyl ester dispersions and polyurethane dispersions, where the solid contents of these dispersions are in the range of 20-70% by weight.

The invention also provides a porous polyurethane coating, obtained by a process according to the invention, wherein the porous polymer coating has a mean cell size of less than 50 μm, preferably less than 40 μm, more preferably less than 30 μm, even more preferably less than 20 μm.

### Foaming Machine

The foaming machines in the invention are conventional and industry standard foaming machines, such as Hansa Mixer from Hansa Industrie-Mixer GmbH & Co. KG and similar machines. Such foaming machines have a line speed of the mixing head of less than 4 m/s. These foaming machines are designed for aqueous foaming application using standard anionic type of surfactant.

### Inline Mixer

Any inline mixing facility can be used in the invention, so long as the inline mixer can provide the desired line speed. Typically, the maximum line speed of the mixing head ranges from: 5˜30 m/s; preferably from 6 m/s to 10 m/s.

In some embodiments, the mixing chamber cavity size can range from 10 to 10000 ml, preferably 50˜500 ml.

In some embodiments, the inline mixer is a colloid mill or homogenizer, which is connected to the existing foaming machine.

Surfactant with Higher Molecular Weight

The invention is especially suitable for applications where polyol ethers and polyol esters are used as a surfactant with higher molecular weight. In some embodiments, the surfactant with higher molecular weight are non-ionic surfactants.

The surfactant with higher molecular weight is preferably selected from the polyol ethers according to WO 2019/042696A1 and the polyol esters according to WO 2018/015260 A1, which are incorporated herein in their entities by reference.

### Polyol Ethers According to WO 2019/042696 A1 (CN 111050897 A):

The term “polyol ethers” in the context of the entire present invention also encompasses the alkoxylated adducts thereof, which can be obtained by reaction of a polyol ether with alkylene oxides, for example ethylene oxide, propylene oxide and/or butylene oxide.

The term “polyol ethers” in the context of the entire present invention also encompasses polyol ester-polyol ether hybrid structures which are prepared by O-alkylation of polyol esters (with regard to the term “polyol esters” see especially the European patent application 16180041.2) or by esterification of polyol ethers.

The term “polyol ethers” in the context of the entire present invention also encompasses the ionic derivatives thereof, preferably the phosphorylated and sulphated derivatives, especially phosphorylated polyol ethers. These derivatives of the polyol ethers, especially phosphorylated polyol ethers, are polyol ethers usable with preference in accordance with the invention.

In some embodiments, the polyol ethers are obtainable by the reaction of a polyol with at least one alkyl halide or alkylene halide, preferably an alkyl chloride, at least one primary or secondary alcohol or else at least one alkyl- or alkenyloxirane, thiirane or aziridine, preferably alkyl epoxide, or obtainable by the reaction of primary or secondary alcohols with glycidol, epichlorohydrin and/or glycerol carbonate.

In some embodiments, the polyols are selected from the group of the C₃-C₈ polyols and oligomers thereof,

preferred polyols being propane-1,3-diol, propylene glycol, glycerol, trimethylolethane, trimethylolpropane, sorbitan, sorbitol, isosorbide, erythritol, threitol, pentaerythritol, arabitol, xylitol, ribitol, fucitol, mannitol, galactitol, iditol, inositol, volemitol and glucose, especially glycerol, and preferred polyol oligomers being the oligomers of C₃-C₈ polyols having 1-20, preferably 2-10 and more preferably 2.5-8 repeat units, particular preference being given here to diglycerol, triglycerol, tetraglycerol, pentaglycerol, dierythritol, trierythritol, tetraerythritol, di(trimethylolpropane), tri(trimethylolpropane) and di- and oligosaccharides, especially sorbitan and oligo- and/or polyglycerols.

In some embodiments, the alkyl halide corresponds to the general formula R-X where X is a halogen atom, preferably a chlorine atom, and where R is a linear or branched, saturated or unsaturated hydrocarbyl radical having 4 to 40 carbon atoms, preferably 8 to 22 and more preferably 10 to 18 carbon atoms,

and preferred alkyl halides are selected from 1-chlorohexadecane, 1-chlorooctadecane, 2-chlorohexadecane, 2-chlorooctadecane, 1-bromohexadecane, 1-bromooctadecane, 2-bromohexadecane, 2-bromooctadecane, 1-iodohexadecane, 1-iodooctadecane, 2-iodohexadecane and/or 2-iodooctadecane, particular preference being given to mixtures of at least two alkyl chlorides.

In some embodiments, the alkyl epoxide corresponds to the general formula 1:

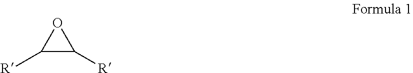

where R′ is, independently at each occurrence, identical or different monovalent aliphatic, saturated or unsaturated hydrocarbyl radicals having 2 to 38 carbon atoms, preferably 6 to 20, more preferably having 8 to 18 carbon atoms or H, with the proviso that at least one of the radicals is a hydrocarbyl radical, particular preference being given here to alkyl epoxides in which exactly one of the radicals is a hydrocarbyl radical, especially preferably epoxides that derive from C₆-C₂₄ alpha-olefins.

In some embodiments, the polyol ethers used include those that are selected from the group of the sorbitan ethers and/or polyglycerol ethers, preferably polyglycerol ethers, preferably those polyglycerol ethers which correspond to the general formula 2:

MₐD_{b}T_{c} Formula 2

where
M=[C₃H₅(OR″)₂O_{1/2}]
D=[C₃H₅(OR″)₁O_{2/2}]
T=[C₃H₅O_{3/2}]
a=1 to 10, preferably 2 to 3, especially preferably 2,
b=0 to 10, preferably greater than 0 to 5, especially preferably 1 to 4,
c=0 to 3, preferably 0,

where the R″ radicals are independently identical or different monovalent aliphatic saturated or unsaturated hydrocarbyl radicals having 2 to 38 carbon atoms, preferably 6 to 20 and more preferably 8 to 18 carbon atoms or H, with the proviso that at least one of the R″ radicals is a hydrocarbyl radical,

and/or correspond to the general formula 3:

MₓD_{y}T_{z} Formula 3

where

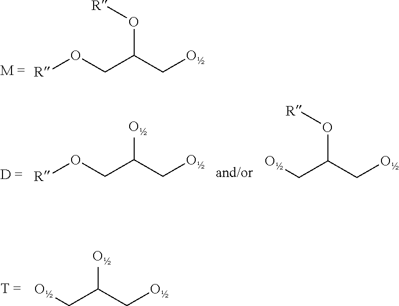

x=1 to 10, preferably 2 to 3, especially preferably 2,

y=0 to 10, preferably greater than 0 to 5, especially preferably 1 to 4,

z=0 to 3, preferably greater than 0 to 2, especially preferably 0,

with the proviso that at least one R″ radical is not hydrogen, still R″ as defined above, and/or correspond to the general formula 4:

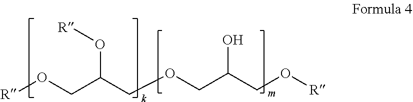

where

k=1 to 10, preferably 2 to 3, especially preferably 2,

m=0 to 10, preferably greater than 0 to 5, especially preferably 1 to 3,

with the proviso that at least one R″ radical is not hydrogen, still R″ as defined above, and that the sum total of k+m is greater than zero and the fragments having the indices k and m are distributed statistically.

In some embodiments, the polyol ethers of the formula 2, 3 and/or 4 have been phosphorylated, especially bear at least one (R″′O)₂P(O)—radical as the R″ radical, where the R″ radicals are independently cations, preferably Na⁺, K⁺ or NH₄⁺, or ammonium ions of mono-, di- and trialkylamines, which may also be functionalized alkyl radicals as, for example, in the case of amide amines, of mono-, di- and trialkanolamines, of mono-, di- and triaminoalkylamines, or H or R″″—O—, where R″″ is a monovalent aliphatic saturated or unsaturated hydrocarbyl radical having 3 to 39 carbon atoms, preferably 7 to 22 and more preferably 9 to 18 carbon atoms or a polyol radical.

In some embodiments, the polyol ethers are used in a blend with at least one ionic, preferably anionic, co-surfactant as additives in aqueous polymer dispersions, preferred ionic co-surfactants being the ammonium and alkali metal salts of fatty acids, alkyl sulphates, alkyl ether sulphates, alkylsulphonates, alkylbenzenesulphonates, alkyl phosphates, alkyl sulphosuccinates, alkyl sulphosuccinamates and alkyl sarcosinates,

preference being given especially to alkyl sulphates having 12-20 carbon atoms, further preferably having 14-18 carbon atoms, even more preferably having more than 16-18 carbon atoms, with the proviso that the proportion of ionic co-surfactant based on the total amount of polyol ether plus co-surfactant is preferably in the range of 0.1-50% by weight, preferably in the range of 0.2-40% by weight, more preferably in the range of 0.5-30% by weight, even more preferably in the range of 1-25% by weight.

### Polyol Esters According to WO 2018/015260 A1 (CN 109476949A):

The term “polyol esters” in the context of the overall present invention also encompasses the alkoxylated adducts thereof, which can be obtained by reaction of a polyol ester with alkylene oxides, for example ethylene oxide, propylene oxide and/or butylene oxide.

The term “polyol esters” in the context of the entire present invention also encompasses the ionic derivatives thereof, preferably the phosphorylated and sulphated derivatives, especially phosphorylated polyol esters. These derivatives of the polyol esters, especially phosphorylated polyol esters, are polyol esters usable with preference in accordance with the invention. These and further derivatives of the polyol esters are described in detail hereinafter, and are usable with preference in the context of the invention.

In some embodiments, the polyol esters are obtainable by the esterification of a polyol with at least one carboxylic acid.

In some embodiments, the polyols are selected from the group of the C₃-C₈ polyols and oligomers thereof,

preferred polyols being propane-1,3-diol, propylene glycol, glycerol, trimethylolethane, trimethylolpropane, sorbitan, sorbitol, isosorbide, erythritol, threitol, pentaerythritol, arabitol, xylitol, ribitol, fucitol, mannitol, galactitol, iditol, inositol, volemitol and glucose, especially glycerol, and preferred polyol oligomers being the oligomers of C₃-C₈ polyols having 1-20, preferably 2-10 and more preferably 2.5-8 repeat units, particular preference being given here to diglycerol, triglycerol, tetraglycerol, pentaglycerol, dierythritol, trierythritol, tetraerythritol, di(trimethylolpropane), tri(trimethylolpropane) and di- and oligosaccharides, especially sorbitan and oligo- and/or polyglycerols.

In some embodiments, the carboxylic acid corresponds to the general formula R—C(O)OH where R is a monovalent aliphatic saturated or unsaturated hydrocarbyl radical having 3 to 39 carbon atoms, preferably 7 to 21 and more preferably 9 to 17 carbon atoms,

and preferred carboxylic acids being selected from butyric acid (butanoic acid), caproic acid (hexanoic acid), caprylic acid (octanoic acid), capric acid (decanoic acid), lauric acid (dodecanoic acid), myristic acid (tetradecanoic acid), palmitic acid (hexadecanoic acid), stearic acid (octadecanoic acid), arachidic acid (eicosanoic acid), behenic acid (docosanoic acid), lignoceric acid (tetracosanoic acid), palmitoleic acid ((Z)-9-hexadecenoic acid), oleic acid ((Z)-9-hexadecenoic acid), elaidic acid ((E)-9-octadecenoic acid), cis-vaccenic acid ((Z)-11-octadecenic acid), linoleic acid ((9Z,12Z)-9,12-octadecadienoic acid), alpha-linolenic acid ((9Z,12Z, 15Z)-9,12, 15-octadecatrienoic acid), gamma-linolenic acid ((6Z,9Z,12Z)-6,9,12-octadecatrienoic acid), di-homo-gamma-linolenic acid ((8Z,11Z,14Z)-8,11,14-eicosatrienoic acid), arachidonic acid ((5Z,8Z,11Z,14Z)-5,8,11,14-eicosatetraenoic acid), erucic acid ((Z)-13-docosenoic acid), nervonic acid ((Z)-15-tetracosenoic acid), ricinoleic acid, hydroxystearic acid and undecenylic acid, and also mixtures thereof, for example rapeseed oil acid, soya fatty acid, sunflower fatty acid, peanut fatty acid and/or tall oil fatty acid,

very particular preference being given to palmitic acid and stearic acid and mixtures of these two substances,

and/or in that a polyfunctional di- and/or tricarboxylic acid is used, preferably aliphatic linear or branched di- and/or tricarboxylic acids having a chain length of 2 to 18 carbon atoms and/or dimer fatty acids that have been obtained by catalytic dimerization of unsaturated fatty acids having 12 to 22 carbon atoms, and/or in that a mixture of carboxylic acid of the general formula R—C(O)OH, as specified above, and polyfunctional di- and/or tricarboxylic acid is used.

In some embodiments, the polyol esters used include those that are selected from the group of the sorbitan esters and/or polyglycerol esters, preferably polyglycerol esters, preferably those polyglycerol esters which correspond to the general formula 1:

MₐD_{b}T_{c} Formula 1

where

M=[C₃H₅(OR′)₂O_{1/2}]

D=[C₃H₅(OR′)₁O_{2/2}]

T=[C₃H₅O_{3/2}]

a=1 to 10, preferably 2 to 3, especially preferably 2,

b=0 to 10, preferably greater than 0 to 5, especially preferably 1 to 4,

c=0 to 3, preferably 0,

where the R′ radicals are independently identical or different radicals of the R″—C(O)— form or H,

where R″ is a monovalent aliphatic saturated or unsaturated hydrocarbyl radical having 3 to 39 carbon atoms, preferably 7 to 21 and more preferably 9 to 17 carbon atoms,

where at least one R′ radical corresponds to a radical of the R″—C(O)— form,

and/or correspond to the general formula 2:

MₓD_{y}T_{z} Formula 2

where

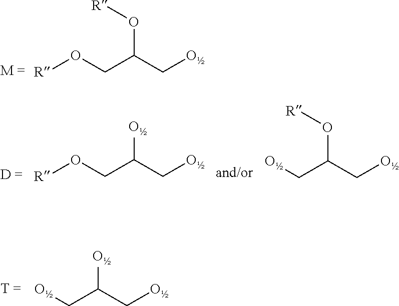

x=1 to 10, preferably 2 to 3, especially preferably 2,

y=0 to 10, preferably greater than 0 to 5, especially preferably 1 to 4,

z=0 to 3, preferably greater than 0 to 2, especially preferably 0,

with the proviso that at least one R′ radical is not hydrogen, still R′ as defined above,

and/or correspond to the general formula 3:

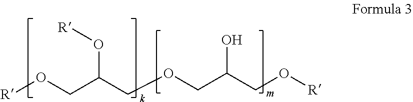

where

k=1 to 10, preferably 2 to 3, especially preferably 2,

m=0 to 10, preferably greater than 0 to 5, especially preferably 1 to 3,

with the proviso that at least one of the R′ radicals is a radical of the R″—C(O)—form, still R′ as defined above, and that the sum total of k+m is greater than zero and the fragments having the indices k and m are distributed statistically.

In some embodiments, the polyol esters of the formula 1, 2 and/or 3 have been phosphorylated, especially bear at least one (R″′O)₂P(O)— radical as the R′ radical, where the R″′ radicals are independently cations, preferably Na⁺, K⁺ or NH₄⁺, or ammonium ions of mono-, di- and trialkylamines, which may also be functionalized alkyl radicals as, for example, in the case of amide amines, of mono-, di- and trialkanolamines, of mono-, di- and triaminoalkylamines, or H or R″′—O—

where R″″ is a monovalent aliphatic saturated or unsaturated hydrocarbyl radical having 3 to 39 carbon atoms, preferably 7 to 22 and more preferably 9 to 18 carbon atoms or a polyol radical.

In some embodiments, the polyol esters are used in a blend with at least one ionic, preferably anionic, co-surfactant as additives in aqueous polymer dispersions, preferred ionic co-surfactants being the ammonium and alkali metal salts of fatty acids, alkyl sulphates, alkyl ether sulphates, alkylsulphonates, alkylbenzenesulphonates, alkyl phosphates, alkyl sulphosuccinates, alkyl sulphosuccinamates and alkyl sarcosinates,

preference being given especially to alkyl sulphates having 12-20 carbon atoms, further preferably having 14-18 carbon atoms, even more preferably having more than 16-18 carbon atoms, with the proviso that the proportion of ionic co-surfactant based on the total amount of polyol ester plus co-surfactant is preferably in the range of 0.1-50% by weight, preferably in the range of 0.2-40% by weight, more preferably in the range of 0.5-30% by weight, even more preferably in the range of 1-25% by weight.

Examples of the preferred surfactant with higher molecular weight is the ORTEGOL® P series from Evonik Industries AG, such as ORTEGOL® P1, ORTEGOL® P2, and ORTEGOL® P4. The ORTEGOL® P series includes innovative foam stabilizers that provide fast foam build-up, outstandingly fine foam structure and superior foam stability. Additionally, the product series is non-migrating, low emissive and provides high system compatibility.

### Water Borne Resin

Any water borne foamable resins may be used in the invention, including aqueous polymer dispersions such as polyurethane dispersion (PUD), acrylic dispersion (PAD), vinyl acetate/ethylene dispersion (VAE emulsion), and latex dispersion, etc.

One advantage of using auxiliary inline mixer is the foam generated from such modification can be much finer and more homogenous, and foams with much finer and more homogenous cell structure can offer unique haptic feeling such as improved softness and resilience.

A further advantage of using auxiliary inline mixer in accordance with the invention is that the foam generated is more stable, e.g., the quality of coating surface can be improved as there will be less coalescence of cells. Firstly, this has an advantageous effect on improved processability such as wider processing window. Secondly, improved foam stability can reduce surface defects such as cell coarsening and drying cracks during drying process. Finally, the improved foam stability enables an increased drying temperature of the foam layer, which leads quicker drying of the foam and consequently higher production line speed. This offers significant processing advantages from both environmental and economic point of view.

Yet another advantage of using auxiliary inline mixer is that it requires no other modification of the existing conventional foaming machine. The inline mixer can be directly and conveniently connected to the existing foaming machine, and the current facilities can be fully utilized without any other additional modification needed. The processing procedure and parameters remain unchanged and there will be no interruption to daily operation. This offers another advantage from an economic point of view.

Therefore, the inventive processes provide a simple and economic way to solve the technical problems that the previously obtained foamed layer shows crack, and the foam cell size is very coarse during continuous and industrial foaming of water borne resins with surfactants of higher molecular weight.

Other advantages of the present invention would be apparent for a person skilled in the art upon reading the specification.

### BRIEF DESCRIPTION OF DRAWINGS

FIG. 1 shows a photo under optical microscopy observation at 500× of the foam obtained in Comparative Example 1.

FIG. 2 shows a photo under optical microscopy observation at 500× of the foam obtained in Example 1.

FIG. 3 shows a photo under optical microscopy observation at 500× of the foam obtained in Example 3.

### DETAILED DESCRIPTION OF THE INVENTION

The invention is now described in detail by the following examples. The scope of the invention should not be limited to the embodiments of the examples.

### Materials and Devices

In the examples, the following materials were used.

PUD 1: KT 736 polyurethane dispersion in water with 50 wt. % solid content (commercially available from Hefei Scisky Waterborne Technology Co. Ltd., Anhui, China).

PAD 1: YF 525 polyacrylic dispersion in water with 50 wt. % solid content (commercially available from Zhejiang YuFeng New Materials Co. Ltd., Zhejiang, China).

Surfactant 1: ORTEGOL® P 2, which is an aqueous dispersion of a surfactant composition based on a non-ionic surfactant with higher molecular weight, from Evonik Industries AG. It is used as foaming agent with waterborne polyurethane dispersions.

Thickener: TEGO® VISCOPLUS 3030, which is polyurethane-based associative thickener from Evonik Industries AG.

The inline mixer used in the examples was a Raschig emulsion colloid mill (Laborzubehör Emulsions-Kolloidmühle, commercially available from Raschig GmbH, Germany)

A lab scale foaming machine (Model WG-SH from Hangzhou WangGe Mechanical Equipment Co. Ltd., Zhejiang, China) with proper setting of pipelines was used to simulate the industrial scale foaming machine.

### Comparative Example 1

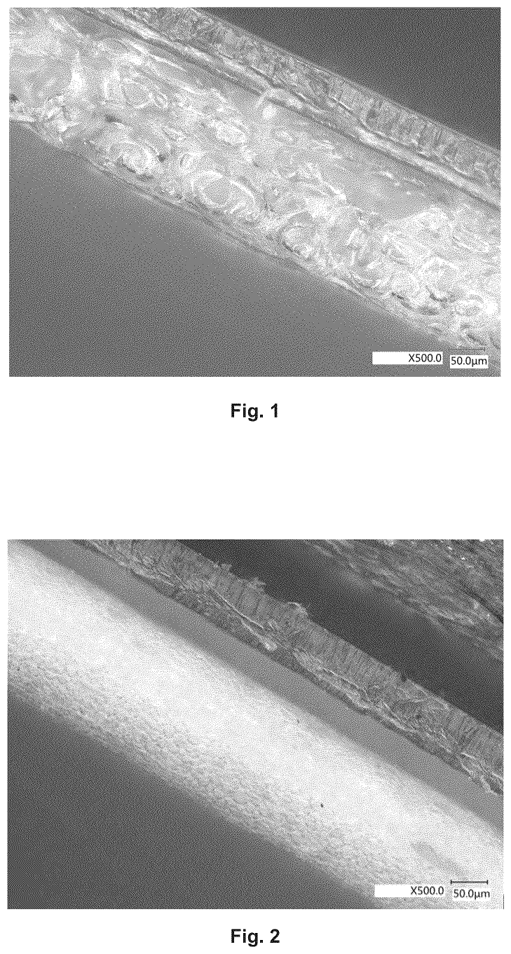

1000 g PUD1, 40 g surfactant 1 and 6 g Thickener were mixed in a 2000 ml beaker at 500 rpm for 3 min to make a PUD premix. For foaming of the mixture, the PUD premix went through the lab scale foaming machine (at a line speed of 1.4 m/s, which was the maximum line speed of the machine). A foam density of 500 g/l was set. The frothed foam was coated to siliconized release paper at the thickness of 300 μm, then dried at the temperature of 60° C. for 5 min, and 120° C. for 5 min. As shown in FIG. 1, the coated foam layer showed cracks and the cells were apparently very coarse from visual inspection of the microscopic view or photo.

### Comparative Example 2

A PUD foam was prepared using the same parameters as in Comparative Example 1, except that the drying condition was changed to 120° C. for 5 min. The prepared foamed layer showed more cracks than Comparative Example 1, and the cells were also very coarse as mentioned in the Comparative Example 1.

### Example 1

A PUD premix was prepared using the same method as Comparative Example 1. The mixture then went through the lab scale foaming machine (at a line speed of 1.4 m/s). The outlet pipe of the foaming machine was connected to the inline mixer. The in-line mixer was mounted with pipelines that directly connected to the upstream foaming machine and downstream coating devices. The auxiliary in-line mixer was chosen so that the inlet flow rate of the auxiliary in-line mixer matched with the outlet flow rate of the foaming machine. To achieve optimal foam structure and stability, the mixing line speed at the outermost point of mixing head was 9.42 m/s and the density of the final frothed foam was set to be 500 g/l. The frothed foam was coated to siliconized release paper at a thickness of 300 μm, then the foam coated paper was dried at 60° C. for 5 min, and then 120° C. for 5 min.

As shown in FIG. 2, the surface of foamed coating was smooth with no crack and the foam cells were much finer.

Compared with the samples of Comparative Examples 1 and 2, the dried samples of Example 1 featured a more homogeneous macroscopic appearance and a more velvety feel. As shown in FIGS. 1 and 2, when the cell structure of the dried samples were assessed by means of optical microscopy, it can be seen that the foam cells of Comparative Example 1 were coarse, and the mean cell size was hard to determine, whereas the samples of Example 1 had a much finer cell size of less than 50 μm and a mean cell size of about 15 μm.

### Example 2

PUD foams were prepared using the same parameters as in Example 1 except that the drying condition was changed to 120° C. for 5 min (without the preceding step of drying at 60° C. for 5 min). The prepared foamed coating surface showed no cracks, and the foam cells were fine. The foamed coating showed no cracks after direct drying at 120° C., which indicated that the foams had a much improved and extraordinary stability.

### Example 3

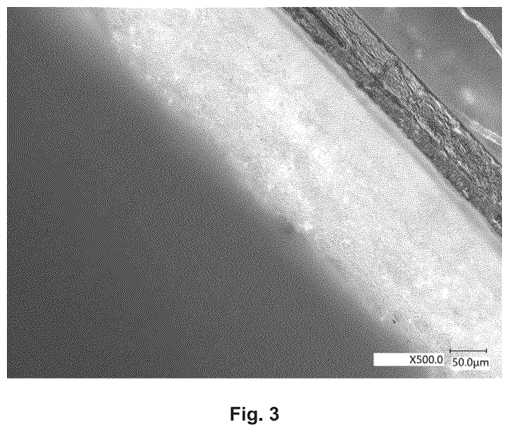

PUD foams were prepared using the same parameters as in Example 1 except that the line speed of the mixing head was set to 18.8 m/s. The prepared foamed coating surface showed no cracks, and the foam cells were fine with some medium sized cell, as can be seen in FIG. 3. Compared with Comparative Example 1, this result indicates that with increased shearing provided by the inline mixer, finer cells can be obtained.

### Example 4

PUD foams were prepared using the same parameters as in Example 2 except that the line speed of the mixing head was set to 18.8 m/s. The prepared foamed coating surface showed no cracks. Compared with Comparative Example 2, this result indicates that with increased shearing provided by the inline mixer, foam stability can be improved.

### Comparative Example 3

1000 g PAD 1, 20 g surfactant 1 and 1 g thickener were mixed in a 2000 ml beaker at 500 rpm (line speed of the mixing head was 1.4 m/s) for 5 min to foam a mixture. Then the mixture went through the lab scale foaming machine and the foam density was set to be 500 g/l. The frothed foam was coated to siliconized release paper at the thickness of 500 μm, drying at 120° C. for 5 min. The foam showed no cracks, but with uneven surface and the cells were coarse.

### Example 5

A PAD foam was obtained using the same parameter as in Comparative_Example 3, except that the foam was further homogenized through the inline mixer (line speed of the mixing head was 9.42 m/s). The foam density was set to be 500 g/l. The coating and drying process was the same as that in Comparative Example 3. The foamed layer after drying was smooth and stable, and the cells were fine.

As used herein, terms such as “comprise(s)” and the like as used herein are open terms meaning ‘including at least’ unless otherwise specifically noted.

All references, tests, standards, documents, publications, etc. mentioned herein are incorporated herein by reference. Where a numerical limit or range is stated, the endpoints are included. Also, all values and subranges within a numerical limit or range are specifically included as if explicitly written out.

The above description is presented to enable a person skilled in the art to make and use the invention, and is provided in the context of a particular application and its requirements. Various modifications to the preferred embodiments will be readily apparent to those skilled in the art, and the generic principles defined herein may be applied to other embodiments and applications without departing from the spirit and scope of the invention. Thus, this invention is not intended to be limited to the embodiments shown, but is to be accorded the widest scope consistent with the principles and features disclosed herein. In this regard, certain embodiments within the invention may not show every benefit of the invention, considered broadly.

1. A method to improve the quality of a foam, produced in a process for continuous production of foams using a surfactant with higher molecular weight as an additive in an aqueous polymer dispersion, the method comprising:
foaming a mixture of an aqueous polymer dispersion and the surfactant with higher molecular weight, wherein the mixture is mixed in a foaming machine with a mixing head line speed of less than 4 m/s; and
mixing the foam obtained from the foaming machine in an auxiliary inline mixer connected to the foaming machine, at a mixing head line speed of 5-50 m/s.

2. The method of claim 1, wherein the surfactant with higher molecular weight is selected from the group consisting of polyol ethers and polyol esters.

3. The method of claim 2, wherein the polyol ethers are obtainable by a reaction of a polyol with at least one alkyl halide or alkylene halide, at least one primary or secondary alcohol, or else at least one alkyl- or alkenyloxirane, thiirane aziridine, or an alkyl epoxide, or obtained by a reaction of primary or secondary alcohols with glycidol, epichlorohydrin, and/or glycerol carbonate.

4. The method of claim 2, wherein the polyol esters are obtainable by esterification of a polyol with a carboxylic acid.

5. A process for continuous production of foams using a surfactant with higher molecular weight as an additive in an aqueous polymer dispersion, the process comprising:
foaming a mixture comprising an aqueous polymer dispersion and the surfactant with higher molecular weight, wherein the mixture is mixed in a foaming machine with a mixing head line speed of less than 4 m/s; and
mixing the foam obtained from the foaming machine in an auxiliary inline mixer connected to the foaming machine, at a mixing head line speed of 5-30 m/s.

6. A process for continuous production of a porous water borne foamable resin coating, using a surfactant with higher molecular weight as an additive in an aqueous polymer dispersion, the process comprising:
a) providing a mixture comprising of an aqueous polymer dispersion, a surfactant with higher molecular weight, and other necessary additives;
b) foaming the mixture to give a foam, wherein the mixture is mixed in a foaming machine at a mixing head line speed of less than 4 m/s;
c) mixing the foam obtained from b) in an auxiliary inline mixer connected to the foaming machine of b), at a line speed of a mixing head from 5-30 m/s, to obtain a foam with homogeneous and fine cell structure;
d) applying a coating of foamed polymer dispersion to a suitable carrier, and
e) drying the coating.

7. (canceled)

8. A continuous production line for production of foams using a surfactant with higher molecular weight as an additive in an aqueous polymer dispersion, the production line comprising:
a foaming machine with a mixing head line speed of less than 4 m/s,
a coating device, and
a drying device, and
an auxiliary inline mixer capable of achieving a mixing head line speed of 5-30 m/s;
wherein an inlet of the inline mixer is connected to an outlet of the foaming machine, and
wherein an outlet of the inline mixer is connected to the an inlet of the coating device.

9. A porous polyurethane coating, obtained by the process according to claim 6, wherein the porous polyurethane coating has a mean cell size of less than 50 μm.

10. The method according to claim 1, wherein the quality of the foam comprises stability of the foam and cell fineness of the foam.

11. The method according to claim 1, wherein the mixing head line speed is from 5-40 m/s.

12. The process according to claim 5, wherein the mixing head line speed is from 6-20 m/s.

13. The process according to claim 6, wherein the porous water borne foamable resin coating is a polyurethane coating.

14. The process according to claim 6, wherein the other necessary additives are selected from the group consisting of thickener, filler, and dispersant.

15. The process according to claim 6, wherein in c), the line speed of the mixing head is from 6-20 m/s.

16. The production line according to claim 8, wherein the auxiliary inline mixer is capable of achieving a mixing head line speed of 6-20 m/s.

17. The porous polyurethane coating according to claim 9, wherein the mean cell size is less than 20 μm.
